(19) United States
(12) Patent Application Publication
(10) Pub. No.: US 2017/0336735 A1
(43) Pub. Date: Nov. 23, 2017

(54) COMPACT, UPRIGHT ELECTROPHOTOGRAPHIC APPARATUS

(71) Applicant: JANGHO YI, Seoul (KR)

(72) Inventor: JANGHO YI, Seoul (KR)

(21) Appl. No.: 14/785,828

(22) PCT Filed: Feb. 14, 2015
(86) PCT No.: PCT/KR2015/001513

§ 371 Date: Oct. 20, 2015

(30) Foreign Application Priority Data
Oct. 21, 2014 (GB) 141948.07

(51) Int. Cl. G03G 15/08

(52) U.S. Cl. CPC G03G 15/0894

(57) ABSTRACT

An electrophotographic image forming apparatus for forming an image on a recording material includes an upright sheet feeding inlet, an upright sheet discharging outlet, a permanently mounted electrophotographic photosensitive drum, and toner replenishing means for refilling a toner reservoir as needed, rendering the device compact, portable, and inexpensive to maintain.

This application claims priority to and is a national stage application under 35 U.S.C. 371 of PCT App. No. PCT/KR2015/001513 to Yi, filed on Feb. 14, 2015 and entitled “Compact, Upright Electrophotographic Apparatus,” which is fully incorporated by reference herein in its entirety.

### BACKGROUND OF THE INVENTION

### Field of the Invention

The present invention relates to an electrophotographic apparatus, and more particularly to a compact, upright electrophotographic apparatus in which all components found in a commercial toner cartridge except toner replenishing means are permanently mounted.

### Background Art

In the above-described type of the electrophotographic apparatus which has so far been used, it is a common practice that a toner cartridge for each color is detachably mounted to the main assembly of the electrophotographic apparatus. The cartridge contains as a unit an electrophotographic photosensitive member and one or more process means such as charging means, developing means, cleaning means, or the like. The cartridge tends to be bulky in size and expensive to replace. It also requires complicated coupling parts and thus it is difficult to maintain and repair the device.

When the electrophotographic apparatus is designed to be set flat, the surface area occupied by the device exceeds the size of a recording medium (recording sheet or the like). When the device is designed to be set upright, the recording medium is discharged onto a flat tray requiring additional space, and a stack of recording sheets loaded in the device is not completely enclosed by the main assembly. Thus, even an upright device may occupy almost as much surface area as a flat device and it is difficult to carry the device to different locations.

In order to overcome the aforementioned disadvantages, a novel, compact electrophotographic apparatus is expected.

### SUMMARY OF THE INVENTION

Accordingly, an object of the present invention is to provide a compact electrophotographic apparatus which is set upright and occupies substantially less surface area than the size of a recording sheet (e.g., A4 or Letter).

It is another object of the present invention to provide a portable electrophotographic apparatus in which trays and loaded recording sheets do not protrude from the device.

It is yet another object of the present invention to provide an electrophotographic apparatus in which all components and means found in a commercial toner cartridge except toner replenishing means are permanently mounted, thereby rendering the device easy and inexpensive to maintain.

The foregoing and other objects of the invention have been achieved by the provision of a compact electrophotographic apparatus in which a substantially completely enclosed sheet feeding inlet is positioned parallel to a sheet discharging outlet. The sheet feeding inlet and the sheet discharging outlet are set upright and separated by a wall situated therebetween. An electrophotographic photosensitive member is permanently mounted to a lower portion of the device. A recording medium traveling through a substantially U-shaped path collects toner particles from the photosensitive member. A toner replenishing means, preferably positioned above the photosensitive member, allows a toner reservoir to be easily refilled as needed without replacing unnecessary components.

The nature, principle, and utility of the invention will be more clearly understood from the following detailed description of the invention when read in conjunction with the accompanying drawings.

### BRIEF DESCRIPTION OF THE DRAWINGS

FIG. 1 is a perspective view of an electrophotographic apparatus according to an embodiment of the present invention.

FIG. 2 is a cross-sectional view of an electrophotographic apparatus according to an embodiment of the present invention.

FIG. 3 is a cross-sectional view of an electrophotographic apparatus to which a toner refilling cartridge is mounted according to an embodiment of the present invention.

FIG. 4 is a sectional view of a toner refilling cartridge and a cartridge compartment according to an embodiment of the present invention.

FIG. 5 is a sectional view of a toner refilling cartridge fully inserted into a cartridge compartment according to an embodiment of the present invention.

FIG. 6 is a perspective view of an electrophotographic apparatus mounted to a flat panel display device according to an embodiment of the present invention.

### DETAILED DESCRIPTION

Embodiments of the present invention will be described in conjunction with the accompanying drawings.

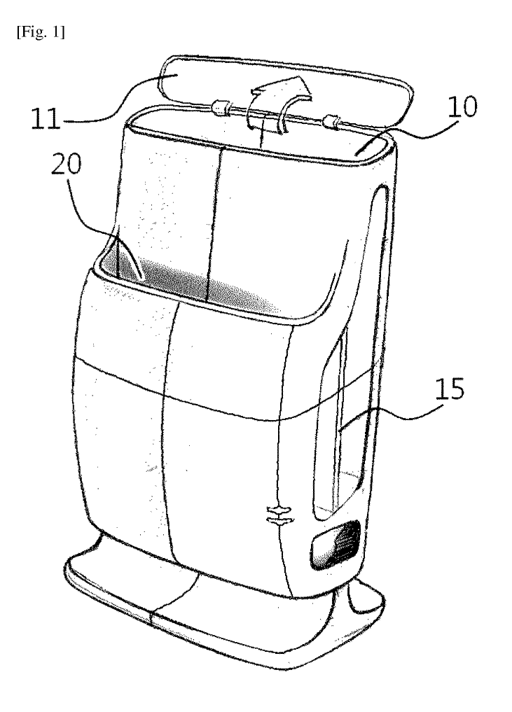

FIG. 1 is a perspective view showing an embodiment of an electrophotographic apparatus according to the present invention. A sheet feeding inlet 10 is enclosed by a rotatable cover 11 which can be opened in the direction of the arrow in the Figure. A recording medium is loaded into the sheet feeding inlet 10 and discharged from a sheet discharging outlet 20. The sheet feeding inlet 10 and the sheet discharging outlet 20 are separated by a wall 15 situated therebetween.

FIG. 2 is a schematic view of the electrophotographic apparatus, in which an electrophotographic photosensitive drum 30 is exposed to a light based on image information supplied from an optical system (not shown) so that a latent image is formed on the photosensitive drum, and the latent image is developed with toner supplied from a toner reservoir 50 into a toner image by a developing roller 40. In synchronism with the formation of the toner image, a recording medium is fed from the sheet feeding inlet 10. The toner image formed on the photosensitive drum 30 is transferred onto the recording medium by voltage application to a transfer roller (not shown) as transferring means. The recording medium is guided to a fixing means (not shown). The fixing means applies heat and pressure to the recording medium to fix the transferred toner image onto the recording medium. Subsequently, the recording medium is discharged to the sheet discharging outlet 20.

The toner reservoir 50 has a hole 60, through which replenishment toner may be injected when needed. The hole 60 is sealed with, preferably, a rubber coated metal cap (not shown) when the device operates in its normal operating mode.

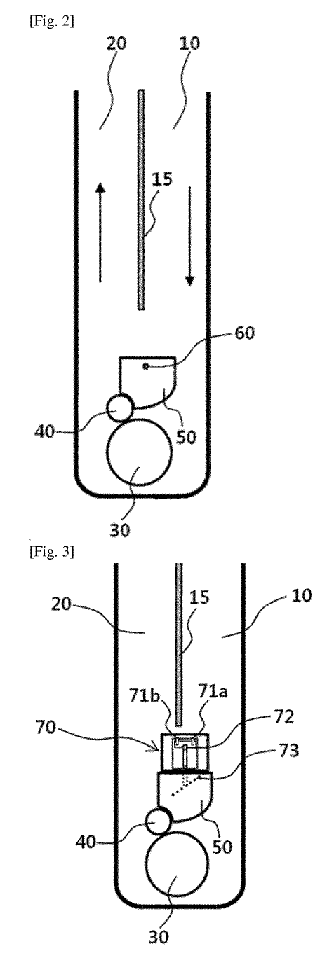

Referring to FIG. 3 to FIG. 5, the description will be made as to a toner refilling cartridge 70 and an electrophotographic apparatus to which it is detachably mountable according to another embodiment of the present invention.

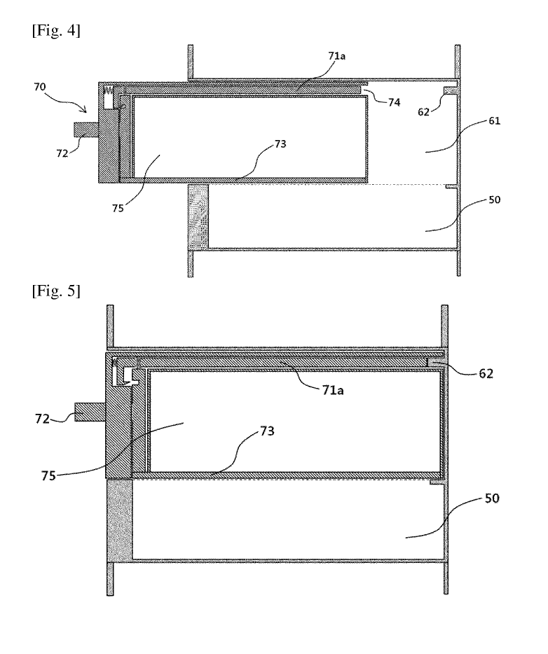

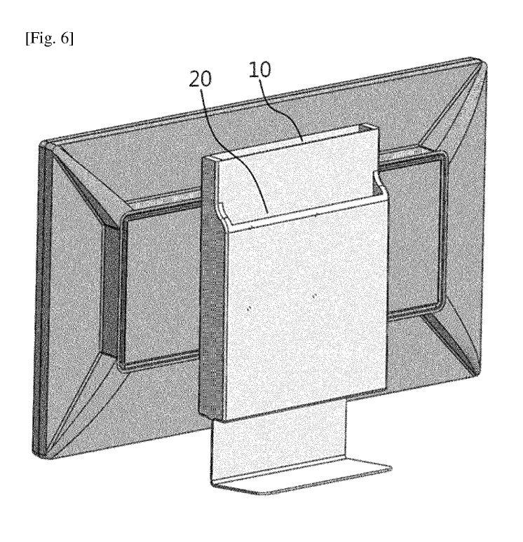

FIG. 3 is a schematic view of the electrophotographic apparatus to which the toner refilling cartridge 70 is mounted; FIG. 4 is a sectional view of the toner refilling cartridge 70 partially mounted to the device; and FIG. 5 is a sectional view of the toner refilling cartridge 70 fully mounted to the device.

In FIG. 3 and FIG. 4, the toner refilling cartridge 70 containing toner inside a toner storage compartment 75 has a toner dispensing door 73 which can be opened by a lever 72. and two latches 71a and 71b which lock or unlock the lever 72. As shown in FIG. 4, the toner refilling cartridge 70 is inserted into a cartridge compartment 61 situated directly above the toner reservoir 50. The latches 71a and 71b are in a locked position rendering the lever 72 inoperable. When the toner refilling cartridge 70 is completely mounted, as shown in FIG. 5, coupling protrusions 62 are inserted into recesses 74 at the longitudinal end of the cartridge 70 moving the latches 71a and 71b away from the lever 72 enabling the lever 72 to open the door 73 and release the toner in the toner storage compartment 75 into the toner reservoir 50.

FIG. 6 is a perspective view of an electrophotographic apparatus according to an embodiment of the present invention and a flat panel display device usable therewith. The electrophotographic apparatus is mounted to the rear side of the flat panel display device.

While preferred embodiments of the invention have been described, it will be obvious to those skilled in the art that various changes and modifications may be made thereto without departing from the invention, and it is aimed, therefore, to cover in the appended claim all such changes and modifications as fall within the true spirit and scope of the invention.

1. An electrophotographic apparatus for forming an image on a recording material, comprising:
an electrophotographic photosensitive drum directly mounted to said apparatus;
charging means for charging said photosensitive drum;
developing means for developing a latent image formed on said photosensitive drum into a toner image;
transfer means for transferring the toner image onto the recording material;
fixing means for fixing the toner image on the recording material;
an upright sheet feeding inlet;
an upright sheet discharging outlet positioned parallel to said sheet feeding inlet, wherein the recording material fed into said sheet feeding inlet and discharged from said sheet discharging outlet travels through a substantially U-shaped path;
a toner reservoir; and
toner replenishing means for replenishing said toner reservoir with toner.

2. An apparatus according to claim 1, wherein said toner replenishing means includes a hole through which toner may be injected into said toner reservoir and a cap for sealing said hole.

3. An apparatus according to claim 1, wherein said toner replenishing means includes a cartridge compartment abutting said toner reservoir and a toner refilling cartridge detachably mountable into said cartridge compartment.

4. An apparatus according to claim 3, wherein said toner replenishing means further includes at least one coupling protrusion at the longitudinal end of said cartridge compartment, wherein said toner refilling cartridge comprises at least one recess located at one longitudinal end of said toner refilling cartridge, a lever or a rotating knob located at the other longitudinal end of said toner refilling cartridge, at least one latch, and at least one door, wherein said latch is in a locked position when said recess is undisturbed, wherein said latch is in an unlocked position when said toner refilling cartridge is fully inserted into said cartridge compartment, forcing said coupling protrusion to enter said recess and move said latch away from said lever or rotating knob, wherein said lever or rotating knob is operable when said latch is in an unlocked position, wherein said lever or rotating knob is inoperable when said latch is in a locked position, wherein operating said lever or rotating knob opens or closes said door, and wherein opening said door allows toner inside said toner refilling cartridge to be dispensed into said toner reservoir.

5. An apparatus according to claim 2, further comprising a rotatable cover enclosing said sheet feeding inlet.

6. An apparatus according to claim 2, wherein at least one side of said sheet feeding inlet and said sheet discharging outlet is constructed with a partially or completely transparent material.

7. An apparatus according to claim 2, wherein said apparatus is mounted to the rear side of a flat panel display device.

8. An apparatus according to claim 3, further comprising a rotatable cover enclosing said sheet feeding inlet.

9. An apparatus according to claim 3, wherein at least one side of said sheet feeding inlet and said sheet discharging outlet is constructed with a partially or completely transparent material.

10. An apparatus according to claim 3, wherein said apparatus is mounted to the rear side of a flat panel display device.
